(19) United States
(12) Patent Application Publication
(10) Pub. No.: US 2012/0065774 A1
(43) Pub. Date: Mar. 15, 2012

(54) GRANULAR MATERIAL VENDING APPARATUS AND METHOD

(76) Inventor: David Peretz, Hollywood, FL (US)

(21) Appl. No.: 12/881,885

(22) Filed: Sep. 14, 2010

(51) Int. Cl. G06F 17/00

(52) U.S. Cl. 700/232

(57) ABSTRACT

One embodiment of the present invention relates to a semi-automated apparatus for vending granular materials in a container comprising a cabinet with a carousel capable of rotating and housing at least one dispensing container. Each dispensing container is adapted to hold granular material and in one embodiment includes a pressure actuated valve. A pneumatic system is coupled to each of the dispensing containers. A motor is coupled to the carousel. The apparatus further comprises a loading station adapted to hold the container, a control system and a user control panel having at least one user interface for controlling operation of the vending machine. The control system, coupled to the motor, the pneumatic system and the user control panel, engages the motor, causing the carousel to rotate, and the pneumatic system, pressurizing the selected dispensing container causing a predetermined amount of granular material to dispense into the vending container.

The present invention relates to a granular material vending apparatus and method, and more specifically, the present invention relates to an apparatus and method for filling receptacles with granular products which may flow from single source dispensing containers.

### BACKGROUND OF THE INVENTION

Dispensing apparatuses and mechanisms have long been known. Such devices range from open containers that are commonly found in retail stores to systems containing closed dispensers that allow a user to manually select and fill tubes or bottles, such as the system described in U.S. Pat. No. 6,619,510 to Green. In '510 to Green, the consumer purchases a container from an attendant and then proceeds to fill the container manually by using a plurality of dispensers that are part of an apparatus. Moreover, the consumer is not restricted in the amount of material or candy the customer can dispense and use, thereby creating the potential for waste and abuse of the dispensing system. One of the drawbacks of the system described in '510 to Green is that a customer could continuously go back to the dispensing containers and obtain more material without paying for the additional product, especially if an attendant is not able to closely monitor the use of the system by the consumer. Accordingly, there is a need for a system that provides control over the dispensing of materials to avoid waste and fraud. There is a need for a system that does not require an attendant to closely monitor the use of the system, but at the same time prevents a customer from dispensing granular materials that he or she is not paying to receive.

Accordingly, there is a need for a novel, semi-automatic vending machine or apparatus where the user can purchase and fill his or her container using a semi-automated process. There is a need for an apparatus that will allow a person to select from one or more dispensing containers granular materials that will automatically dispense into another container such that the person is able to create a granular filled container having materials ordered and arranged by the person. For example, a person using such a device could create an artwork of granular materials of different colors and then have the completed product delivered to that person by the device. There is a need to have an apparatus that allows a customer to select different granular materials by using buttons, a joystick or other user interfaces, and thus control the quantity and layers of granular materials dispensed by a vending machine, and thus producing a custom vended product of granular material.

### OBJECTS OF THE INVENTION

The following section of the written description describes some of the objects of the present invention, but the section is not exhaustive of all of invention's objects.

It is an object of the present invention to provide an apparatus that allows a user to fill a receptacle container with granular materials, such as sand, nutritional powder or candy, by using a consumer interface device to select from one or more dispensing containers to fill the receptacle container to a predetermined level.

It is a further object of the present invention to provide an apparatus that automates the dispensing of the granular material into a container.

It is yet another object of the present invention to provide an embodiment of the apparatus that fills cylinders or tubes with materials selected by the user to create a clear or translucent cylinder or tube filled with different layers of granular material or powdered candy in a layer by layer manner.

It is a further object of the present invention to provide a method of dispensing granular materials that allows a user to select from one or more granular material dispensing containers.

It is yet a further object of the present invention to provide an apparatus that automatically cuts off the filling of receptacle containers with granular materials when the container is filled or when a specific amount of material or time has transpired and return said product to the customer.

### SUMMARY OF THE INVENTION

The present invention relates to a semi-automated apparatus for vending granular materials in a vending container to a user. The apparatus comprises a cabinet and a carousel suspended within the cabinet. The carousel is capable of rotating and houses at least one dispensing container. Each of the dispensing containers is adapted to hold granular material. Each of the dispensing containers further comprises a pressure actuated valve. A motor is coupled to the carousel. A pneumatic system is coupled to each of the dispensing containers. The apparatus further comprises a loading station adapted to hold the vending container, a control system and a user control panel having at least one user interface adapted to accept input from the user for controlling operation of the vending machine. The user interface further comprises a joystick and a button. The control system is coupled to the motor, the pneumatic system and the user control panel, and the control system engages the motor to cause the carousel to rotate to position at least one dispensing container over the vending container based upon input from the user. The control system engages the pneumatic system to pressurize the dispensing container positioned over the vending container causing a predetermined amount of the granular material to dispense into the vending container.

The present invention further comprises a user access area coupled to a front side of the cabinet and a vending container holder. The holder is adapted to retain the vending container, and the holder is attached to a rod to move the holder from the user access area to the loading station.

An alternative embodiment of the present invention further comprises a funnel coupled to the cabinet and positioned to capture the granular material as it is dispensed into the vending container. A grommet may be coupled to the bottom of the funnel in order to provide a seal between the bottom of the funnel and an open end of the vending container.

The apparatus of the present invention may further comprise a spindle coupled to the cabinet. The spindle is adapted to store at least one vending container. It may further comprise a vacuum nozzle coupled to the cabinet and positioned at the loading station. The nozzle is coupled to the pneumatic system. The control system engages the pneumatic system to evacuate or suction air through the nozzle when granular material is dispensed into the vending container. In this manner, any spillage or small particulates are evacuated.

The semi-automated apparatus for vending granular materials may also comprise a pneumatic system coupled to each the dispensing containers through a rotatable distribution system.

An alternative embodiment of the present invention comprises a semi-automated apparatus for vending granular materials in a vending container to a user with a cabinet, at least one dispensing container coupled to the cabinet, with each of the dispensing containers adapted to hold granular material and each of the dispensing containers further comprising a valve. The embodiment further comprises a loading station adapted to hold the vending container, and a ramp coupled to the cabinet and positioned below each of the dispensing containers. The ramp is shaped to funnel the granular material to the loading station at a position above the vending container. The present invention further comprises a user control panel having at least one user interface adapted to accept input from the user for controlling operation of the vending machine. It also comprises a control system coupled to the valve of each of the dispensing containers. The user control panel and the control system engages each of the valves to cause one of the valves to open until a predetermined amount of the granular material exits from a selected dispensing container.

### BRIEF DESCRIPTION OF THE DRAWINGS

The subject matter which is regarded as the invention is particularly pointed out and distinctly claimed in the claims at the conclusion of the specification. The foregoing, and other objects, features, and advantages of the present invention are shown and described in the following detailed description of the preferred embodiments which should be viewed in conjunction with the accompanying drawings in which:

FIG. 1 illustrates an exemplary embodiment of a self contained vending machine that dispenses granular materials;

FIG. 2 illustrates another embodiment of a self contained vending machine that dispenses granular materials;

FIG. 3 diagrammatically illustrates components of one embodiment of the present invention;

FIG. 4 diagrammatically illustrates one embodiment of the carousel used to hold the dispensing containers of granular material;

FIG. 5 illustrates one embodiment of an automatic container feeding, filling and capping device;

FIG. 6 illustrates an embodiment of the container holder being transported through the user access area while retaining a clear or translucent tube-shaped container;

FIG. 7 illustrates a partial-perspective view of the carousel;

FIG. 8 illustrates a bottom view of an exemplary embodiment of a dispensing container showing the pressure-actuated valve;

FIGS. 9 and 10 diagrammatically illustrate the operation of the pressure-actuated valve;

FIG. 11 illustrates an exemplary embodiment of the dispensing container with a pneumatic system coupled to the container;

FIG. 12 diagrammatically illustrates an alternative embodiment of the system having stationary dispensing containers;

FIG. 13 diagrammatically illustrates the control system for the container holder mechanism;

FIG. 14 diagrammatically illustrates the control system for the carousel and pneumatic system, and a rotating air manifold;

FIG. 15 illustrates a block diagram of the overall control system;

FIG. 16 illustrates a top view of a vacuum nozzle that is used to remove small particulate matter that is suspended in the air surrounding the granular material as it is being dispensed into the container;

FIG. 17 illustrates an embodiment of the pneumatic distribution system that is used to pressurize the dispensing containers;

FIG. 18 illustrates an alternative embodiment that uses a disk-shaped structure to hold the user container; and

FIG. 19 illustrates an embodiment that includes a capping and de-capping station for use in connection with the user container.

### DETAILED DESCRIPTION OF THE PREFERRED EMBODIMENTS

The present invention relates to the field of vending and amusement devices. Specifically, the present invention relates to an apparatus and method for dispensing, in an automated manner, granular products, such as sand or candy, that allow the operator of the apparatus to select the type of filling material to be dispensed from one or more dispensing containers using a user interface. The apparatus and method of the present invention dispenses specific predetermined amounts of the granular product into a container, such as a clear tube, figurine or bottle, which is later dispensed directly to the operator of the vending machine. The present invention allows the user operator to individually select the colors or flavors of the granular product to be dispensed into a vended container, thus allowing the user to create his or her own product.

It is important to note that the embodiments of the invention described below are only examples of some of the uses of the teachings described herein. In general, statements made in the specification do not limit any of the various claimed inventions. Moreover, some statements may apply to some inventive features but not to others. Unless otherwise indicated, singular elements may be in the plural and vice versa with no loss of generality. Similar reference numerals and letters represent similar components and system features throughout the drawings and the written description.

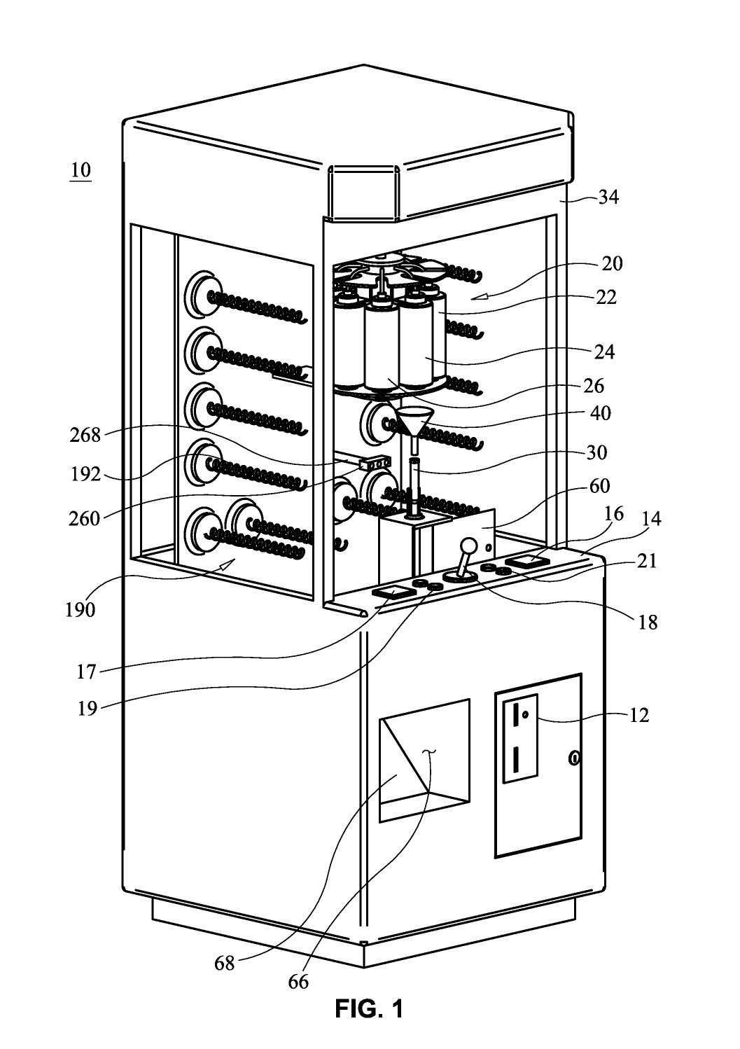

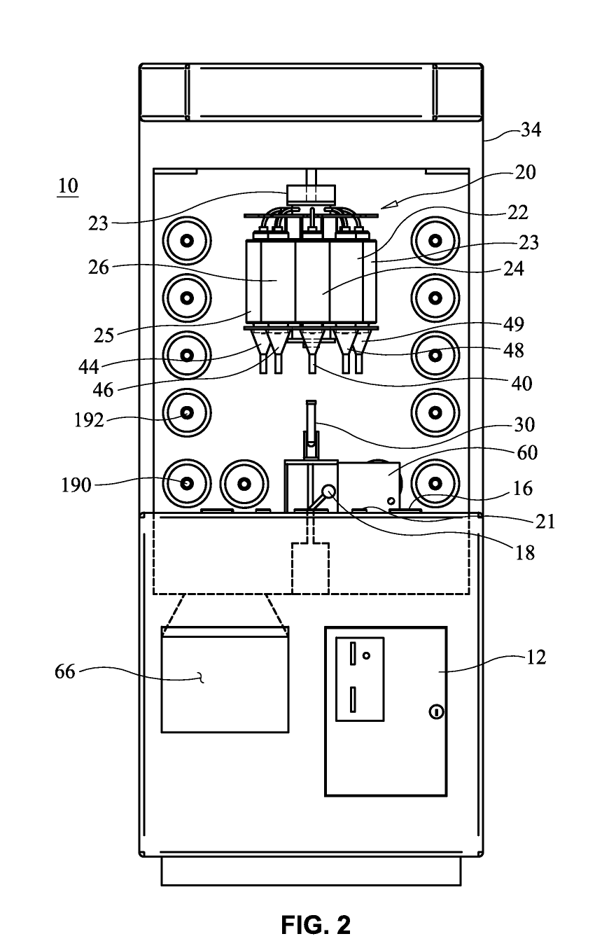

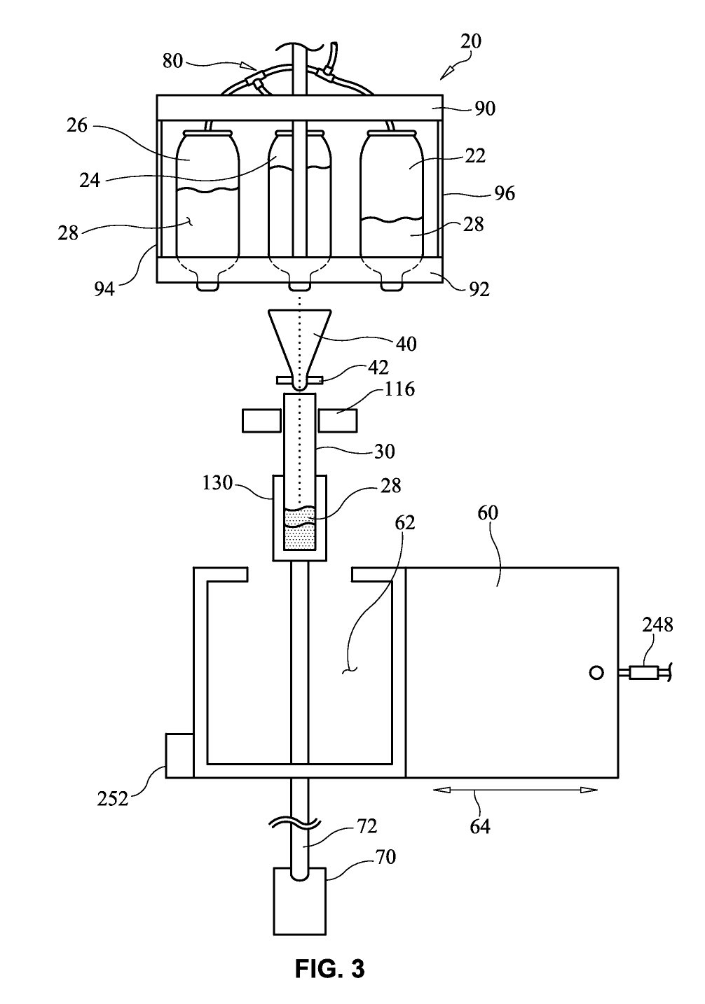

FIGS. 1 and 2 illustrate exemplary embodiments of a self contained vending apparatus or machine 10 that dispenses granular materials. In order to provide context to the description of the various subcomponents described below, a brief explanation of the vending process follows. The embodiments of FIGS. 1 and 2 are each a self-contained vending machine 10 that dispenses, using an automated process, granular material such as edible candy art, nutritional powder or colored sand art. The vending machine 10 may be activated by using a coin-operated interface or a paper bill-operated interface or a card interface as is known in the art (see reference no. 12). The customer, using a control panel 14 located on the outside of the vending machine, selects the color or flavor associated with the dispensing container(s) 22, 24, 26 from a carousel 20 that is operated by the buttons 16 and/or a joystick 18 outside the vending machine. Once a specific flavor or color is selected by the user or operator, using joystick 18 of the vending machine 10, incremental amounts of granular material associated with the selected flavor or color is dispensed by pushing a button 16 on the control panel 14 that automatically dispenses the product into a clear container. The quantity of granular material that is dispensed is controlled by the number of times the button 16 on the control panel 14 is pushed by the operator. The amount of granular material dispensed by pushing button 16 is predetermined by the machine and is not adjustable by the customer. As more fully described below, the vending machine 10 is preset to allow a specific amount of air pressure to fill one of the dispenser containers 22, 24, 26 when the selected container are in the loading zone over the funnel 40. In addition, the length of time that air pressure is added to the particular dispensing container 22, 24, 26 is predetermined and controlled by the vending machine control system 200 rather than the operator. It is the combination of air pressure and the length of time the air pressure is allowed to flow into the dispenser container that determines the amount of granular material 28 that can be added to the receptacle container 30 during one push of button 16. By using the variety of color or flavors available from the dispensing carousel 20, the operator can layer a pattern of colors to create a unique pattern within the container 30. See FIG. 3.

The vending sequence for one exemplary embodiment is as follows: Customer credits vending machine using interface 12. Button 17 is used to select one of a plurality of spindles 190, 192 loaded with empty containers and caps 30. Next, button 19 is used to activate the selected spindle 190 to drop one of the loaded containers into chute 68. After the container drops down to vending area 66, the door 60 of the user access area 62 slides open exposing loading station (holder) 130 to customer. The customer is prompted by digital speech and lights to place the empty container (without cap) in 130. Next, the door 60 automatically closes and raises the empty container 30 into the loading station located under the funnel 40. Next, the user moves the joystick 18 to the left or right to select the dispenser 20, 22, 24 that the user wants to use to fill the container 30. Once the container 30 is filled to a predetermined level as determined by a sensor 116 coupled to the control system, the dispensing button 16 is deactivated by the control system 200 and the container 30 is lowered down back inside the user access area 62 and the door 60 slides open to allow the user to remove the filled container 30.

In the embodiment illustrated in FIG. 1, the vending apparatus 10 consists of multiple multi-favored/colored granular dispensers or dispensing containers 22, 24, 26 which can be positioned over a funneling device 40 to fill a user container 30. Although one dispensing container 24 could be used, in the preferred embodiment, two or more dispensing containers 22, 24, 26 are used to give the user operator the ability to choose from different materials. In FIG. 2, an alternative embodiment is illustrated having a funnel 44, 46, 40, 48, 49 positioned under each respective dispensing container 25, 26, 24, 23, such that there is substantially little or no gap between the top of the funnel and bottom of the carousel. This embodiment prevents fine particulates of the granular material 28 from escaping from the dispensing containers during the dispensing process. The user container 30 can be any receptacle container capable of holding granular materials, but preferably is a clear tube, cylinder, or bottle so that the user is able to observe the material 28 in the container while the granular material is being dispensed by the apparatus 10. For example, the receptacle container 30 may also be a figurine-shaped container or any logo-shaped container. In one embodiment, the vending process provides the user with a clear container 30 and a cap 32 (not shown in FIGS. 1 & 2) to be used on the container after the vending process (see FIG. 3). The user is able to place the container 30 into the vending machine 10 to be filled with granular material. Once the container 30 is filled, a sensor or electronic metering device 116 turns off the dispensers and returns the filled container 30 back to the user via an access door 60 in the vending machine in the container loading area 62. In this embodiment, the user may select the amounts of each flavor or color of granular material that is added to the clear container 30 until the container 30 is either filled or a specific time has elapsed. In another embodiment, the vending machine 10 will randomly fill the container 30 to the top and then dispense the finished product back to the user, where the user will then place a cap on the filled container 30.

FIG. 3 diagrammatically illustrates components of one embodiment of the present invention 10. In addition to illustrating some of the basic components related to the dispensing of granular material 28, FIG. 3 includes motor 70 that lifts the container 30 held by holder 130. Container holder 130 is supported by rod or shaft 72. FIG. 3 also shows user access area 62 in the open position with the door 60 open. Door actuator 248 can comprise any number of devices used to control the opening and closing of door 60 along the directions of arrow 64. For example, a pneumatic piston or stepper motor or linear motor may be used to control the opening and closing of door 60. FIG. 3 also shows a fill sensor 116 used to determine when the container 30 has been properly filled. Above the container 30 is a funnel 40 used to direct the granular material 28 as it falls by the force of gravity into the container. In the embodiment illustrated in FIG. 3, a washer-shaped grommet 42 is placed at the smaller diameter opening of the funnel 40. The purpose of the grommet 42 is to substantially seal the opening of the container 30 against the bottom of the funnel 40 to avoid granular material 28 from spilling out and spreading on the equipment in the apparatus. Over the funnel 40 is the carousel 20 holding the dispensing containers 22, 24, 26. The dispensing containers 22, 24 26 of FIG. 3 also illustrate a pneumatic system 80 that is used to cause granular material 28 to dispense from a predetermined dispensing container. The pneumatic system 80 is used to internally pressurize the user selected dispensing container 22, 24, 26. The pressurized container 24 causes the granular material 28 to exit through the valve located at the bottom of the container 24, as described in greater detail below. See FIGS. 9 through 12.

One embodiment of the carousel 20 used to hold the dispensing containers is illustrated in FIG. 4. The carousel 20 includes a top plate 90, bottom plate 92 and vertical support members 94, 96. The carousel 20 is supported from the ceiling of the cabinet using a “U” bracket 114 that wraps around carousel 20 to the base of the carousel and allows shaft 100 hanging from above to hold the carousel on a central axis of rotation using ball bearings 98, 106, 102 and 105. The entire carousel substructure 20 is mounted to the top of the cabinet 34 with a centrally mounted ball bearing assembly 98 and the entire carousel assembly 20 can be rotated around this central point with a gear box and electric motor 110. The carousel 20 spins about shaft 100 and includes bearings 98, 102, 105 106. Disk 104 at the bottom of the carousel 20 prevents the carousel 20 from falling. See FIG. 7. Near the top of shaft 100 is a pulley 108 that is coupled to step motor 110 by belt 112, alternately motor 110 can be mounted directly to shaft 100 and no belt would be used.

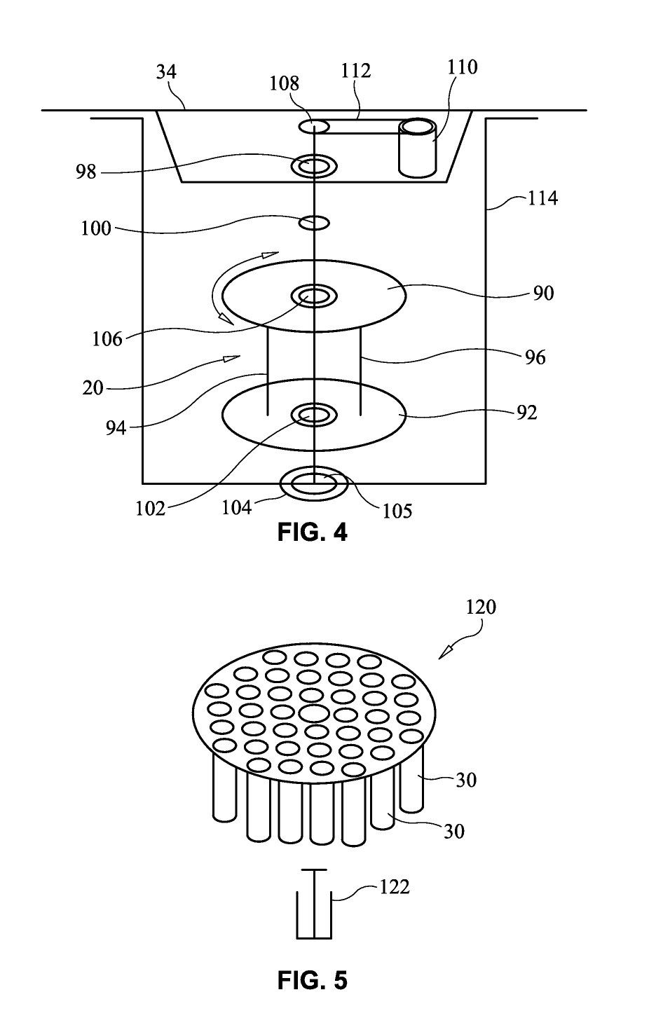

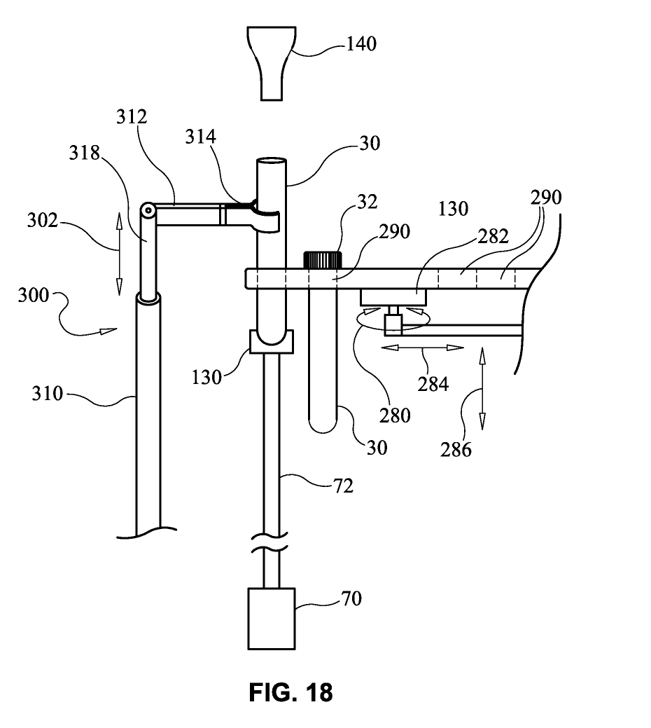

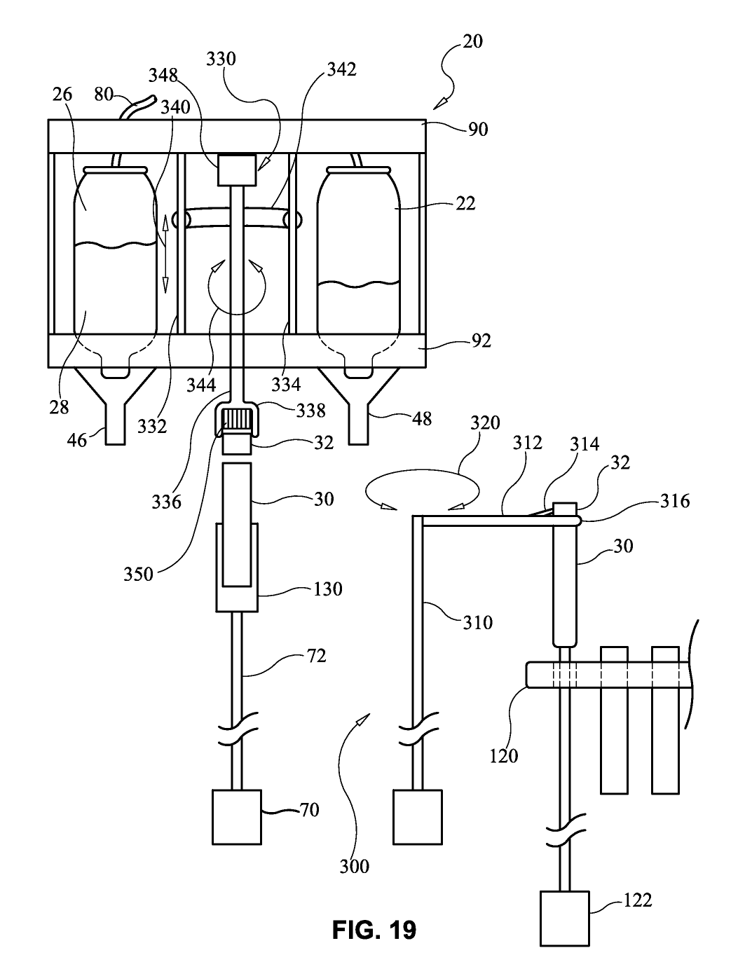

FIG. 5 illustrates another embodiment of a container 30 storage 120 capable of holding several test tube shaped containers 30 with caps 32 attached to be used by the apparatus 10. The tube container storage 120 of the illustrated embodiment is disk shaped and defines several holes sized to fit a plurality of tube-shaped containers 30 with caps attached within respective holes. The size of the holes are such that the capped part of the containers 30 are slightly wider, and thus do not fall though the holder 120. Although illustrated as having a disk shape, other shapes may used. For example, a rectangular-shaped plate could also be used. Alternatively, a conveyor belt-like structure could also be used. In the embodiment of FIG. 5, a piston 122 is used to select a particular container on the disk shaped container holder 120. Upon being properly aligned, the piston is designed to lift a predetermined container 30 upward out of the container holder 120 such that the container 30 may be used by the user of the vending machine 10, or alternatively, a different component of the vending machine located above the container 30 retains the container for use. An embodiment illustrating this arrangement is described below in connection with FIGS. 18 and 19.

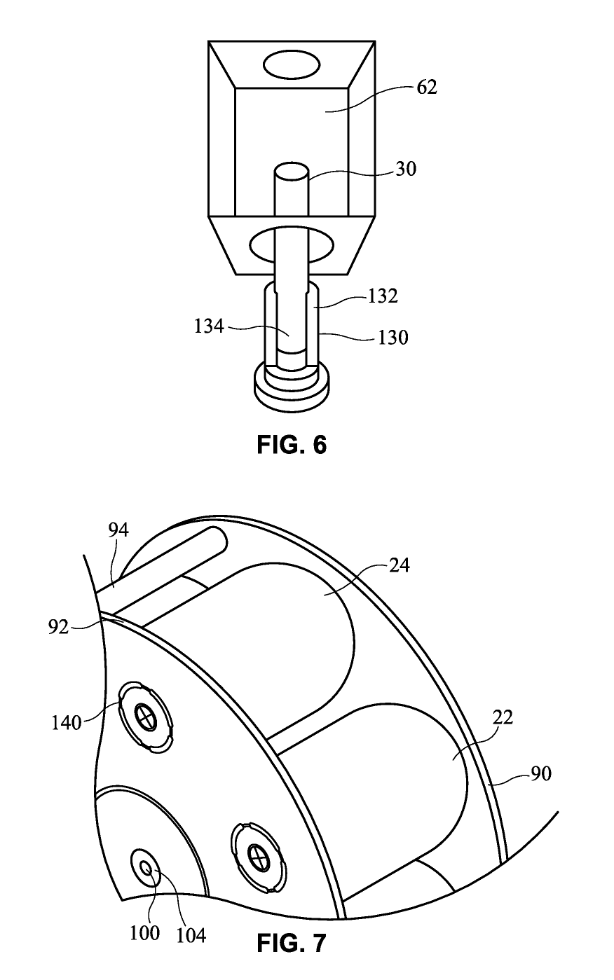

FIG. 6 illustrates an embodiment of the container holder 130 being transported through the user access area 62 while retaining a tube-shaped container 30. The container holder 130 comprises a c-shaped segment 132 sized to hold container 30 within its interior wall. The open area 134 faces the user of the apparatus 10 such that the user is able to observe the granular material 28 (see FIG. 3) within container 30 as the container is being filled.

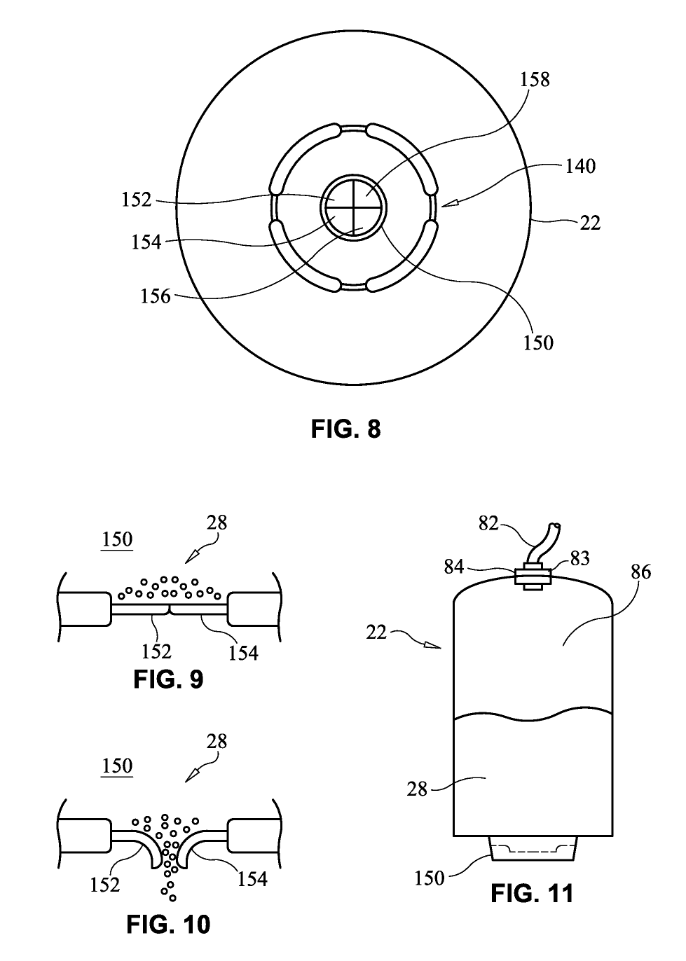

FIG. 7 illustrates a partial-perspective view of the carousel showing the exposed bottom 140 of the dispensing containers 22, 24. FIG. 8 illustrates a bottom view of an exemplary embodiment of a dispensing container 22 showing the pressure-actuated valve 150. FIG. 11 illustrates the dispensing container 22 with a hose 82 of the pneumatic system 80 coupled to the top of the container 22. In the preferred embodiment, the hose 82 is connected to a dispensing container cap 84 that can be removed by depressing the quick release collar or tab 83, so that the container cap 84 can be unscrewed from the top of the dispensing container 22. This design allows access to the dispensing container 22 so that it may be refilled with granular material 28 or replaced with a new dispenser during maintenance and upkeep of the apparatus 10. Although not illustrated, it should be appreciated by those skill in the art that a simple gravity-based dispensing system may be implemented as an alternative to the pneumatic system. In a gravity based system, each dispensing container 22, 24, 26 would include a valve at the bottom of the container. Upon selecting a particular dispensing container, the valve associated with the particular dispensing container would be engaged, opening the valve, and allowing granular material 28 to fall by the force of gravity into the funnel and the vending container 30 below. The valve could be electrically or pneumatically actuated and controlled.

FIGS. 9 and 10 diagrammatically illustrate the operation of the pressure-actuated valve. In one embodiment, the valve 150 is comprised of a flexible material such as silicon having pie-shaped members 152, 154, 156, 158. As illustrated in FIG. 9, in a rested or normal position, the valve members 152, 154 are aligned, forming a barrier and holding granular material 28 from exiting the dispensing container 22. However, upon pressurizing the dispensing container 22 through the use the one way valve cap 84 (see FIG. 11) via the pneumatic system 80, the increased pressure causes the valve members 152, 154 to be pushed outward, and allows the granular material 28 to exit the dispensing container 22 as illustrated in FIG. 10.

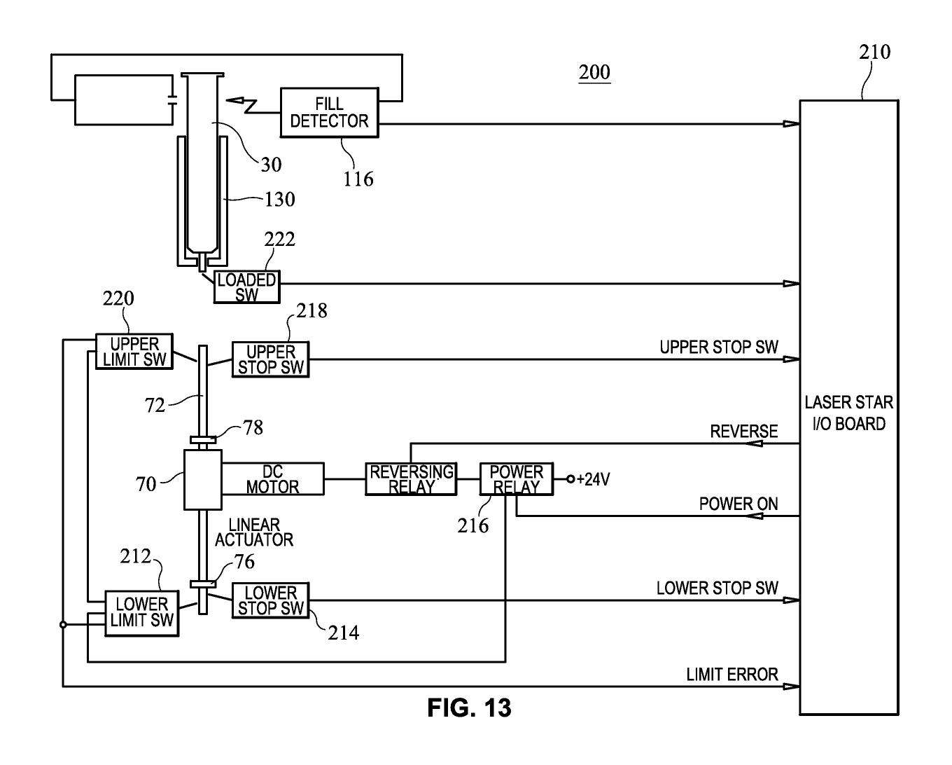

Several control components can be used to automate the vending apparatus 10. FIG. 13 diagrammatically illustrates one embodiment of a control system 200 for the tube-shaped container holder system. The control system 200 comprises several limit switches and detectors electrically coupled to a circuit board 210 having various input/output terminals. The circuitry that controls the operation of the device 10 may be implemented using a simple processor, logic circuit, a programmable array, or a combination of these components, as would be understood by one of ordinary skill in the art.

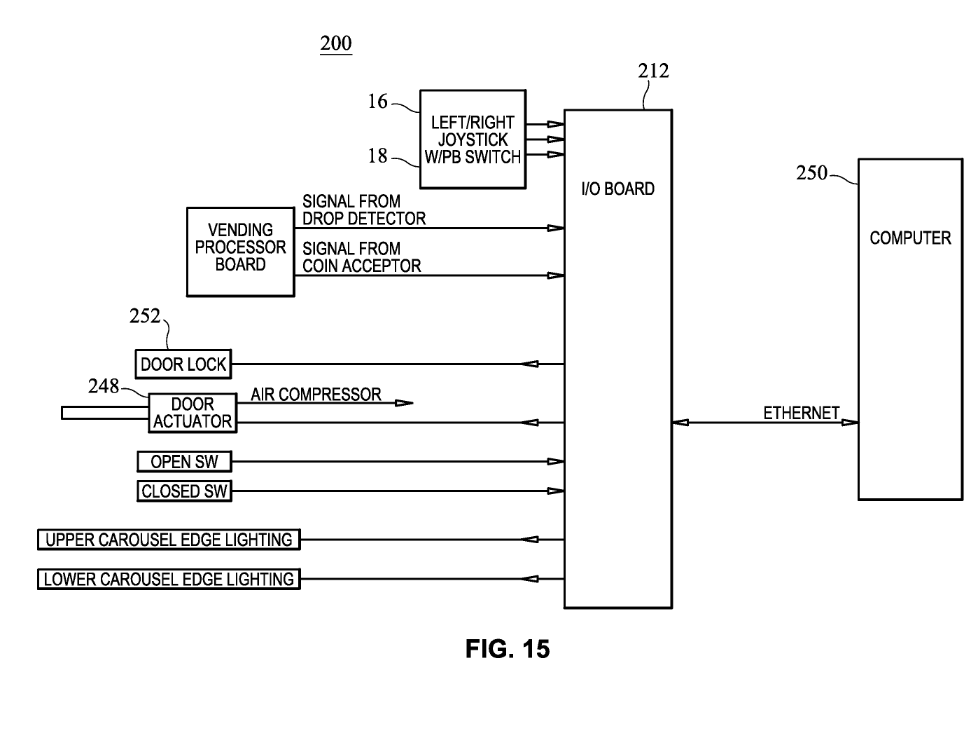

The system illustrated in FIG. 15 includes a computer processor 250. FIG. 13 illustrates one exemplary embodiment of the control system 200. The motor 70 controlling the positioning of the user container 30 includes a lower limit switch and a lower stop switch 214. Once the shaft 72 cross bar 76 reaches lower stop switch 214, the logic circuit sends a signal to power relay 216 to disengage gear motor 70, thus stopping the shaft 72 from going any further in a downward direction. If lower stop switch 214 fails to operate, lower limit switch 212 signals the logic circuit, causing an interruption power to the motor 70, thus preventing damage from occurring to the container holder assembly 130 and/or loading compartment 62 and causing a limit switch error to be reported to the control system 200. The logic circuit is then programmed to send an error message and reset the system. The control system 200 also includes an upper stop switch 218 and upper limit switch 220. Similar to the lower counterparts, the upper limit switch 218 provides feedback to the logic circuit to signal when the shaft 72 upper cross bar 78 has reached the upper stop switch 218. The upper limit switch 220 also generates an error signal that the logic circuit handles similar to the lower limit switch. The control system 200 also includes a container holder 130 load switch 222. The load switch provides feedback on the condition of the container holder 130. When loaded, the switch is depressed, thus signaling the circuit that the system may proceed. In addition to the foregoing, other control switches may be implemented. For example, the access door 60 may also include a switch 252 (FIG. 15) to ensure that the user does not have his or her hands in the access box 62 area. Fill detector 116 is a sensor that is used to determine both when the container 30 has been properly filled and if the container was improperly inserted by the user into holder 130 with the cap on the container. If sensor 116 determines the cap was left on the container by user error, the control system 200 will return the container back to user access area 62 for the user to reinsert the container without the cap on the container. This can be implemented through an optical sensor.

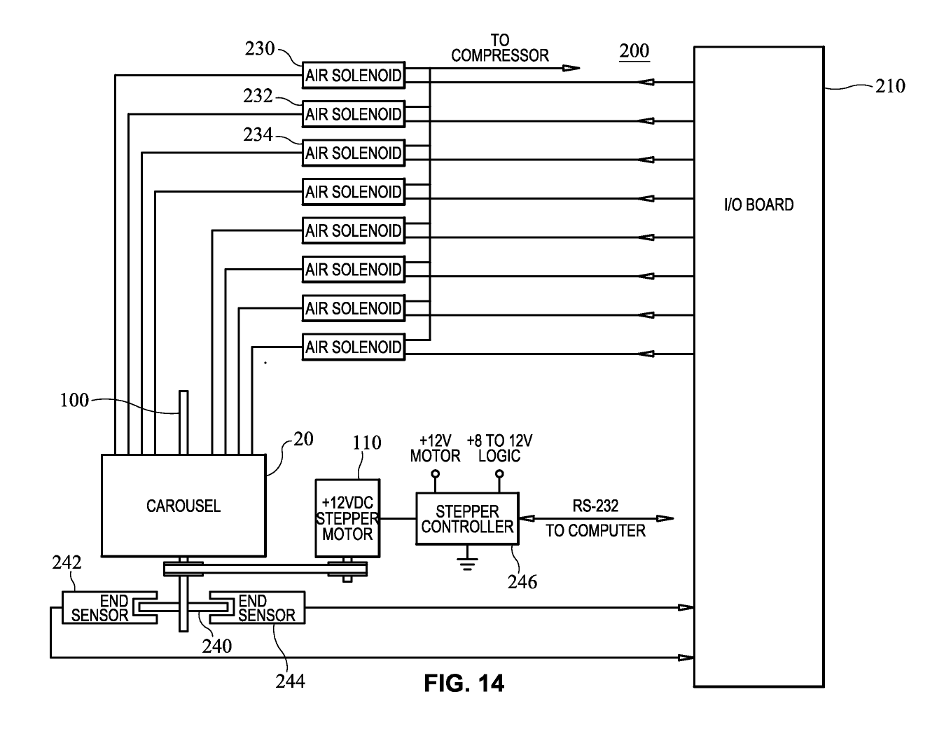

FIG. 14 diagrammatically illustrates the control system 200 for the carousel 20 and pneumatic system 80. Each dispensing container 22, 24, 26 is connected via a pneumatic hose to a respective air solenoid 230, 232, 234. The logic circuit energizes the proper air solenoid with a predetermined amount of air to pressurize the dispensing container selected by the user such that the granular material contained within the dispensing container exits. The shaft 100 of the carousel 20 has a control member 240 that is shaped to interact with two limit sensor switches 242, 244. As the step motor 110 turns the carousel 20 in a rotational direction, the control member 240 rotates about shaft 100. When the ends of the control member 240 interact with either of the end sensors 242, 244, a control signal coupled to the input/output board 210 provides feedback to the logic circuit. The circuit controls the step motor 110 through the stepper controller 246. In the illustrated embodiment, rotation of the carousel 20 is limited to 360 degrees so that the tubing 82 does not become tangled or damaged.

FIG. 15 illustrates a block diagram of the overall control system, including circuits used to control the operation of the joystick 18, pushbuttons 16, door actuator 248, door lock 252, various limit switches, lighting for the machine 10, and various other components, such as sound effects and coin/bill inputs.

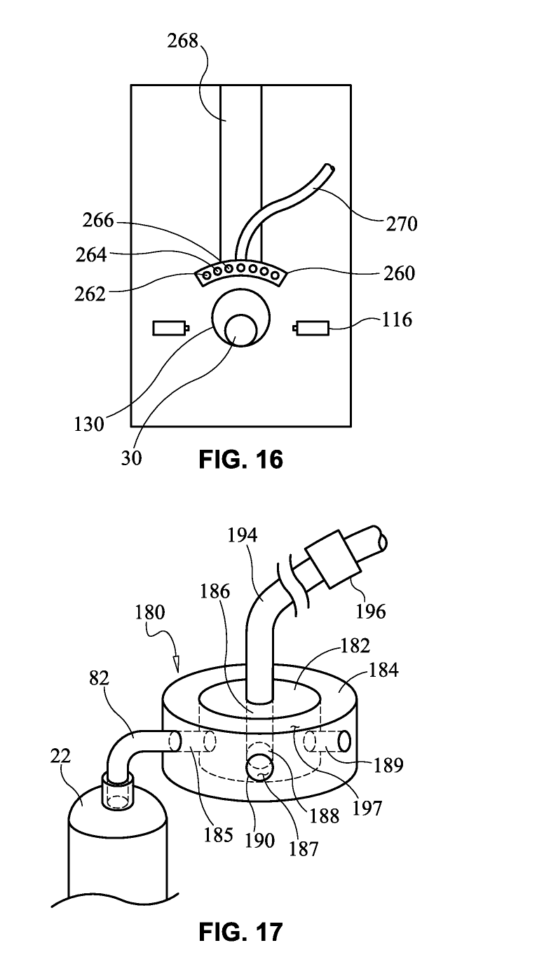

FIG. 16 illustrates a top view of a vacuum nozzle 260 that is used to remove small particulate matter or spillage that is suspended in the air surrounding the granular material 28 as it is being dispensed into the container 30. In one embodiment, a nozzle 260 may be positioned about the transfer area between the container 30 and funnel nozzle to capture any spillage using suction. Nozzle 260 is supported through member 268 against the back of the cabinet 34. Nozzle 260 is comprised of a manifold defining one or more holes 262, 264, 266 through which air is suctioned. A vacuum hose 270 is attached to one end of the manifold. The vacuum hose 270 is connected to a solenoid valve (not shown) that is controlled through the control circuit 200. During operation of the apparatus 10, a mist comprising of suspended, fine, particulate, material 28 may form as the granular material 28 is being transferred from the dispensing containers 22, 24, 26, through the funnel 40 and into the container 30. The nozzle 260 may be used to remove the spillage mist during the filling process.

FIG. 17 illustrates an embodiment of the pneumatic distribution system 180 that is used to pressurize the dispensing containers 22, 24, 26. The pneumatic distribution system 180 comprises a rotating manifold having an inner stationary disk shaped member 182 and an outer, complimentary disk shaped member 184. The stationary member 182 defines a passageway 186 having a terminal end 188 on the interior, vertical face 197 of member 182. The terminal end 188 is substantially aligned with the vertical axis where the selected dispensing container 22, 24, 26 is aligned once rotated over the funnel 40. The other end of passageway 186 is pneumatically coupled to solenoid 196 via hose 194. The rotating member 184 rotates together with the carousel 20 and defines passageways 185, 187, 189 that are pneumatically coupled to each of the dispensing containers. In FIG. 17, dispensing container 22 is pneumatically coupled to the rotating member 184 via pneumatic hose 82 (the other dispensing containers are not shown). The passageways 185, 187, 189 of rotating member 184 each terminate on the interior vertical wall of the rotating member 184 such that the interior open end of the passage is only aligned with the terminal end 188 of the passageway 186 on the interior stationary member 182 when the outer rotating member reaches an anterior or forward facing position 190. This pneumatic system 180 permits the control system 200 to pressurize only the selected dispensing container 22, 24, 26 when it is properly aligned, reaching an anterior or forward facing position over the funnel 40.

In an alternative embodiment, operation of the carousel-based embodiment is fully automated and overcomes many of the shortcomings of the prior, manual systems. FIGS. 18 and 19 illustrate an alternative embodiment that uses a disk-shaped structure to hold the user containers 30, and a capping and de-capping station to automate the loading of the user container 30. FIG. 18 illustrates an alternative container storage disk 120 similar to the one illustrated in FIG. 5. The container storage 120 may be comprised of any shape capable of holding the containers. A disk shaped container storage 120 is preferred because it allows for rotation of the disk in the direction shown by double headed arrow 280. A motor 282 may be used to control the rotational movement of the disk shaped container 120. Other means may also be utilized as known to those of skill in the art. The disk shaped container 120 may also include means to control movement in the horizontal (x-axis) direction 284 and the vertical (y-axis) direction 286. The disk shaped storage 120 defines holes 290 that are shaped and sized to hold user containers 30. The container storage 120 is positioned such that the container holder 130 is able to be moved into a position below a predetermined container 30. During operation, the lifting means 70 is engaged, causing the shaft 72 to move the container holder 130 below the container 30 until it comes into contact with the bottom of the container 30, thus forcing the container to move upward and out of the hole 290 where the container 30 was stored. The alternative embodiment of FIG. 18 includes clamping device 300. Clamping device 300 is comprised of a substantially vertical, movable member 310, a substantially horizontal member 312 and clamp members 314, 316. Movable member 310 is designed to move up and down as shown by double-headed arrow 302. The illustrated embodiment includes a telescoping member 318 that is used to move the clamping device 300 up and down.

In action, the clamping device 300 lifts the container 30 out of the storage disk 120 and brings it up to the filling station. At the end of the filling process, the clamping device 300 drops the container 30 down the ramping system to the chute where the user picks up his filled product with cap 32 screwed on to the top of the container 30. In this embodiment, the containers 30 are inserted into the disk 120 with screw caps on them. The clamping device 300 holds the container 30 during the uncapping, filling, and the recapping process.

FIG. 19 illustrates an alternative embodiment having a clamp device 300 capable of rotating in the direction of double-headed arrow 320. This additional structure allows for the container 30 to first be removed from the storage disk 120 and subsequently rotated onto holder 130 for elevation into the filling area or station. In FIG. 19, the carousel 20 includes a capping and de-capping station 330. This station 330 uses approximately the same amount of space as a dispensing container 22 within the carousel structure 20. The station is comprised of two guide rails 332, 334, shaft 336, capping member 338 and motor 338. The guide rails 332, 334 are used to guide the capping and de-capping mechanism in the substantially vertical direction as indicated by double-headed arrow 340. The number of guide rails implemented may vary. Shaft 336 is coupled to the substantially horizontal guide member 342. Guide member 342 may be designed using a ring-like structure. Guide member 242 is coupled to the guide rails 332, 334 such that the entire structure comprising the guide member 342, shaft 336, capping member 338 and motor 348 move up and down. Motor 348 is used to cause rotational movement of shaft 336 in the direction shown by double-headed arrow 344. Capping member 338 comprises a socket-like structure sized to accept a cap 32 from a container 30. Capping member 338 may comprise small, movable splines 350 that shift and move about within the socket-like structure in order to grasp a cap 32 as the cap enters the interior of the structure. Alternatively, the interior of the socket-like structure may be conically shaped such that the structure forms a friction fit with a cap 32 as the structure and the cap are compressed together.

Operation of the automated process may be carried out as follows. The user inputs coins or bills to pay for use of the vending machine 10. Piston 122 pushes a container 30 with cap 32 attached to the container 30 above disk 120 where a clamping device 300 lifts the container 30 and either pushes it under the carousel 20 (FIG. 18) or rotates it into position under the carousel 20 (FIG. 19). Next, capping and decapping device 330, located on carousel 20, is lowered onto the cap 32 until the cap 32 is within socket-like structure of the capping member 338. The motor 348 turns, causing rotation of the cap 32. After sufficient rotation to allow the cap to be removed, the capping and de-capping device 330 is lifted, thus removing the cap on the container and allows for the de-capped container to be filled by the user once the user selects the dispensing container 22, 26. Next, the system 10 energizes the push buttons 16 and joystick 18. The user is then able to select a dispensing container 22, 24, 26 by using the joystick 18 to rotate the carousel 20 such that one of the dispensing units 22, 24, 26 filled with a user desired colored and/or flavored granular material 28 can be dispensed, using button 16, into the user tube 30. At this time, the upper portion of the user container 30 is aligned with the bottom portion of the funnel 40. If no user selection is made within a predetermined amount of time, the system will randomly select a color(s) or flavor(s) from among dispensing containers 22, 24, 26 having granular material 28. The motor 70 is engaged and the container holder 130 with the container 30 is lowered until the lower stop switch 218 is engaged. Once the selection is made (by pressing button 16, the control system 200 energizes the solenoid valve 230, 232, 234 associated with the aligned dispensing container and the pressure is released into the selected dispensing container 22, 24, 26. The compressor sends a predetermined amount of air via pneumatic system 80 into the selected dispensing container. The air enters the upper section of the dispensing container 22, 24, 26 via the air hose 82 attached to the top of the container. Once the pressure reaches a predetermined level or a predetermined amount of air is pumped into the dispensing container, the granular material 28 exits through the pressure valve 140 at the bottom of the container 22, 24, 26. At the end of the filling process, container 30 is dispensed through a user vending area such as 66 (see FIG. 1).

In the semi-automatic embodiment, the container 30 is placed by the user into the container holder 130 within user access area 62. Once the door 60 is closed, the system controller 200 raises the user container 30 up into the loading position under funnel 40 and to allow the container 30 to be filled with granular material 28. Next, the system energizes the push buttons 16 and joystick 18. The user is then able to select a dispensing container 22, 24, 26 by using the joystick 18 to rotate the carousel 20 such that one of the dispensing units 22, 24, 26 filled with a user desired colored and/or flavored granular material 28 can be dispensed, using button 16, into the user tube 30. At this time, the upper portion of the container 30 is aligned with the bottom portion of the funnel 40. If no user selection is made within a predetermined amount of time, the system will randomly select a color(s) or flavor(s) from among dispensing containers 22, 24, 26 having granular material 28. The motor 70 is engaged and the container holder 130 with the container 30 is lowered until the lower stop switch 218 is engaged. Once the selection is made (by pressing button 16), the control system 200 energizes the solenoid valve 230, 232, 234 associated with the aligned dispensing container and the pressure is released into the selected dispensing container 22, 24, 26. The compressor sends a predetermined amount of air via pneumatic system 80 into the selected dispensing container. The air enters the upper section of the dispensing container 22, 24, 26 via the air hose 82 attached to the top of the container. Once the pressure reaches a predetermined level or a predetermined amount of air is pumped into the dispensing container, the granular material 28 exits through the pressure valve 140 at the bottom of the container 22, 24, 26.

Periodically, the dispensing containers 22, 24 26 must be either replaced or refilled with granular material 28. The carousel 20 position is controlled with the stepper motor 110. For example, the carousel 20 may include slotted notches to allow rollers with switches to provide feedback to the control system 200 regarding the position of the dispensing container 22, 24, 26. Once the carousel 20 is stopped and a particular dispensing container 22, 24, 26 is over the funnel 40 and loading station, the user can incrementally fill the clear tube 30 under the loading station by pushing a button 16 which will activate an air solenoid valve that is pneumatically coupled to the particular dispensing container. Each time button 16 is pushed by the user, only an incremental blast of air fills the dispensing container thereby limiting the amount of product permitted to be dispensed per button pushed 16. The electronic control system 200 of the apparatus 10 limits the amount of air that can be added to the dispenser thereby regulating the amount of granular product 28 allowed to the user in an incremental amount. The optic sensor 116 provides for an upper limit and feedback to the control system 200 that the user container 30 is full and the vending is completed. The pneumatic system used with the dispensing containers 22, 24, 26 also serves as a unique method to prevent clogging of the bottom valve by clearing the valve with internal pressure which is a common problem found with other gravity filled devices. In the illustrated embodiment, the pneumatic attachments at the top caps of the dispensing containers 22, 24, 26 are harnessed together at the center of the carousel 20 and the control system sensors will only allow rotation of the carousel 20 within a predetermined range within 360 degrees, depending on the number of dispensing containers and the space between the individual containers. This limitation prevents the pneumatics and the control system wiring that are attached to the carousel 20 from becoming tangled. The dispensing of granular material 28 from the carousel is activated once the user has selected the particular dispensing container 22, 24, 26 and that container is in the proper loading position. In an alternate embodiment, the use of a rotating manifold such as the one illustrated in FIG. 17 allows for the carousel to rotate continuously in any direction without the pneumatic tubes becoming tangled.

The clear tube container 30 is held under the loading area through the use of a container holder 130. Once the tube is filled, the tube container 30 and container holder 130 are lowered down to the door assembly area 62. After a predetermined time, the user is able to open the door 60 and remove the container 30 from the apparatus 10. In one embodiment, an electronic display timer or an internal timer will be used to limit the amount of time the user has to fill product into the tube container 30. This unique feature maximizes the earning potential of the apparatus 10 and represents an advancement over self-vending manual systems presently available. Moreover, there is no need to have an attendant monitoring the amount of time the user is occupying the system. Manual, prior systems have no time restrictions, and there is a potential for abuse of the dispensing of products by the user. Also eliminated by the present system is the ability of a user to continuously fill and eat an edible granular material 28 from their tube 30. The present invention 10 automatically dispenses a tube with a predetermined amount of granular material 28.

The present invention may also comprise a system that initially vends a container 30 having a cap 32. The present invention may also comprise a spindle system 190, 192 used to dispense a container 30 having a cap 32. The spindle system 190 may include a number of containers 30 with caps 32 that are dispensed into a chute area 66. Once a pre-packaged container 30 and cap 32 are dispensed into the chute area 66 from the spindle 192, there is a lock out door 68 which allows the user to pick up the container 30 and cap 32 from the machine 10. Once a container 30 and cap 32 have been dispensed into the chute, the control system 200 of the vending machine 10 activates the access door 60 located above the control panel 14 which allows the user to load the tube 30 without the cap 32 on the container inside of the machine 10 in the user access area 62. The next step in the vending process is the vending door 60 opens, which allows the user to take the container 30 without the cap 32, and load it manually into the holder 130 located behind the sliding vending door 60. The container 30 is loaded into a holder 130 and the door 60 is closed by the user by depressing a control button 21. Once the door 60 is closed by linear motor or pneumatic piston 248, the control system 200 of the apparatus 10 then raises the container 30 up into the final loading position using motor 70 or a pneumatic piston. Once the container is in the final loading position, a sensor activates the rotating dispensing carousel 20 to operate. At this time, a timer starts and the user can begin adding user selected the flavor/colored granules or powder.

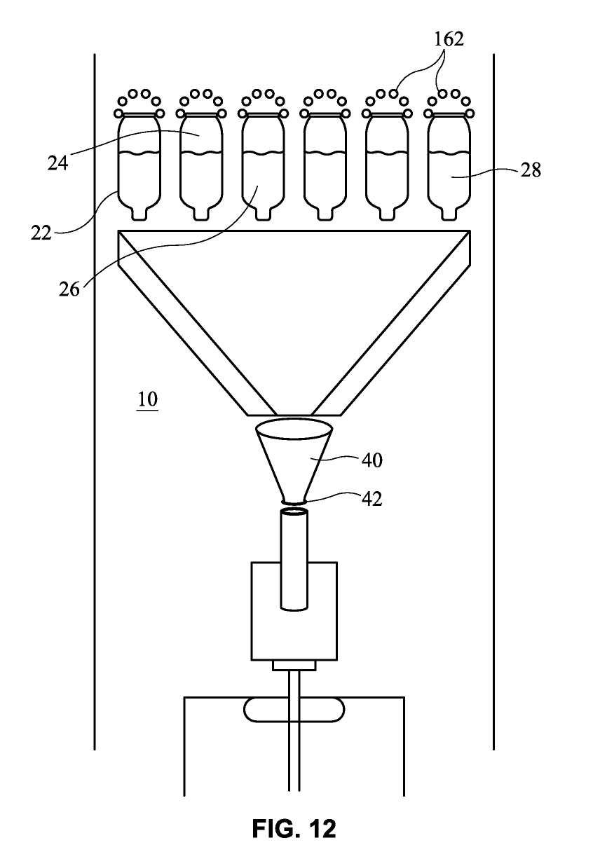

FIG. 12 diagrammatically illustrates an alternative embodiment of the system 10 having six stationary dispensing containers (see 22, 24, 26). The alternative embodiment has the dispensing containers mounted in a substantially immobile manner. A ramp-like structure 160 is placed below the exit ports of each of the dispensing containers so that the structure funnels the granular material 28 to the funnel 40. Although the ramp-like structure 160 is illustrated as open so as to allow the vending machine user to see the granular material 28 as it falls downward, a closed structure may also be implemented. The alternative device includes the use of lighting 162 to indicate to the user of the machine which of the dispensing containers 22, 24, 26 is active and ready to dispense 28 into the container 30.

Instead of the rotating carousel, the plurality of dispensing containers 22, 24, 26 will be mounted on the back wall of the vending machine 10 above a ramp structure 160. Once the granular materials 28 are selected from a particular dispensing container 22, 24, 26, the pitched ramp 160 will direct the granular material 28 using gravity into a funnel 40 that serves as the loading area for the clear container 30. In this embodiment, light(s) associated with each dispensing container 22, 24, 26 notify the user of the active container. The light(s) associated with each dispensing container will move from container to container as the user moves the joystick 18, on the control panel 14 left or right. Once a particular dispensing container is chosen, the dispensing container that is lit will dispense incremental granular material 28 when the user hits the fill button 16 located on the control panel 14.

The present invention 10 provides a semi-automated dispensing apparatus 10 for dispensing user-determined amounts of granular material 28 stored in bulk in one or more individual storage dispensing containers 22, 24, 26. Each dispensing container is connected to a pneumatic system 80 and control system 200 that automates the dispensing of material through the use of operator selected push buttons 16 and/or joysticks 18. The granular material 28 is transported into a container 30 which is vended to the user at the end of the process.

The claims appended hereto are meant to cover modifications and changes within scope and spirit of the present invention.

What is claimed is:

1. A semi-automated apparatus for vending granular materials in a vending container to a user, the apparatus comprising:
a cabinet;
a carousel suspended within said cabinet and capable of rotating, said carousel housing at least one dispensing container, each said dispensing container adapted to hold granular material, each said dispensing container further comprising a pressure actuated valve;
a motor coupled to said carousel;
a pneumatic system coupled to each said dispensing container;
a loading station adapted to hold the vending container;
a user control panel having at least one user interface adapted to accept input from the user for controlling operation of the vending machine; and
a control system coupled to said motor, said pneumatic system and said user control panel; said control system engaging said motor to cause said carousel to rotate to position said at least one dispensing container over the vending container based upon input from the user; said control system engaging said pneumatic system to pressurize said at least one dispensing container positioned over the vending container causing a predetermined amount of the granular material to dispense into the vending container.

2. A semi-automated apparatus for vending granular materials as claimed in claim 1 further comprising:
a user access area coupled to a front side of said cabinet;
a vending container holder, said holder adapted to retain the vending container, said holder attached to a rod to move said holder from said user access area to said loading station.

3. A semi-automated apparatus for vending granular materials as claimed in claim 2 further comprising:
a spindle coupled to said cabinet, said spindle coupled to a motor to turn said spindle, and said spindle adapted to hold at least one of the vending container;
wherein said control system is coupled to said motor of said spindle and wherein said control system engages said motor of said spindle based upon input from the user from said at least one user interface.

4. A semi-automated apparatus for vending granular materials as claimed in claim 3 further comprising at least one vending container, said vending container comprising a clear material and having a tube shape.

5. A semi-automated apparatus for vending granular materials as claimed in claim 1 further comprising a funnel coupled to said cabinet and positioned to capture said granular material as it is dispensed into the vending container.

6. A semi-automated apparatus for vending granular materials as claimed in claim 5 further comprising a grommet coupled to the bottom of said funnel, said grommet providing a seal between the bottom of the funnel and an open end of the vending container.

7. A semi-automated apparatus for vending granular materials as claimed in claim 1 wherein said at least one user interface further comprises a joystick and a button.

8. A semi-automated apparatus for vending granular materials as claimed in claim 1 further comprising a vacuum nozzle coupled to said cabinet and positioned at said loading station, said nozzle coupled to said pneumatic system, said control system causing said pneumatic system to suction air through said nozzle when said granular material is dispensed into the vending container.

9. A semi-automated apparatus for vending granular materials as claimed in claim 1 wherein said pneumatic system coupled to each said dispensing container further comprises a rotatable distribution system pneumatically coupled to at least one of said dispensing containers.

10. A semi-automated apparatus for vending granular materials as claimed in claim 9 wherein said rotatable distribution system is mounted to said carousel and is further comprised of a rotating manifold having an inner stationary member and an outer rotating member, said outer rotating member pneumatically coupled to each of said at least one dispensing containers.

11. A semi-automated apparatus for vending granular materials as claimed in claim 2 further comprising a rotatable vending container storage coupled to said cabinet, said vending container storage adapted to store at least one of the vending container.

12. A semi-automated apparatus for vending granular materials as claimed in claim 11 further comprising a clamping device coupled to said cabinet, said clamping device comprising clamping members adapted to remove the vending container from said vending container storage into said vending container holder.

13. A semi-automated apparatus for vending granular materials as claimed in claim 1 further comprising an optic sensor coupled to said cabinet; said control system coupled to said optic sensor; wherein said optic sensor provides feedback to said control system when the vending container has been filled with a predetermined amount of the granular materials.

14. A semi-automated apparatus for vending granular materials in a vending container to a user, the apparatus comprising:
a cabinet;
at least one dispensing container coupled to said cabinet, each said dispensing container adapted to hold granular material, each said dispensing container further comprising a valve;
a loading station adapted to hold the vending container;
a ramp coupled to said cabinet and positioned below each of said at least one dispensing container, said ramp shaped to funnel the granular material to said loading station at a position above the vending container;
a user control panel having at least one user interface adapted to accept input from the user for controlling operation of the vending machine; and
a control system coupled to said valve of each said at least one dispensing container and said user control panel; said control system engaging each said valve to cause one of the valves to open until a predetermined amount of the granular material exits from said at least one dispensing container.

15. A semi-automated apparatus for vending granular materials as claimed in claim 14 further comprising:
a user access area coupled to a front side of said cabinet;
a vending container holder, said holder adapted to retain the vending container, said holder attached to a rod to move said holder from said user access area to said loading station.

16. A semi-automated apparatus for vending granular materials as claimed in claim 14 further comprising a funnel coupled to said cabinet and positioned below said ramp to capture said granular material as it is dispensed into the vending container.

17. A semi-automated apparatus for vending granular materials as claimed in claim 16 further comprising a grommet coupled to the bottom of said funnel, said grommet providing a seal between the bottom of the funnel and an open end of the vending container.

18. A semi-automated apparatus for vending granular materials as claimed in claim 14 further comprising:
a spindle coupled to said cabinet, said spindle coupled to a motor to turn said spindle, and said spindle adapted to hold at least one of the vending container;
wherein said control system is coupled to said motor of said spindle and wherein said control system engages said motor of said spindle based upon input from the user from said at least one user interface.

19. A semi-automated apparatus for vending granular materials as claimed in claim 18 further comprising at least one vending container, said vending container comprising a clear material and having a tube shape.

20. A semi-automated apparatus for vending granular materials as claimed in claim 14 wherein said at least one user interface further comprises a joystick and a button.

21. A semi-automated apparatus for vending granular materials as claimed in claim 14 further comprising a vacuum nozzle coupled to said cabinet and positioned at said loading station, said nozzle coupled to a pneumatic system, said control system causing said pneumatic system to suction air through said nozzle when said granular material is dispensed into the vending container.

22. A semi-automated apparatus for vending granular materials as claimed in claim 14 further comprising a visual indicator coupled to said cabinet at a location adjacent each of said at least one dispensing container, each said visual indicator coupled to said control system, wherein said control system causes said visual indicator to signal based upon said input from the user.

23. A semi-automated apparatus for vending granular materials as claimed in claim 15 further comprising a rotatable vending container storage coupled to said cabinet, said vending container storage adapted to store at least one of the vending container.

24. A semi-automated apparatus for vending granular materials as claimed in claim 23 further comprising a clamping device coupled to said cabinet, said clamping device comprising clamping members adapted to remove the vending container from said vending container storage into said vending container holder.

25. A semi-automated apparatus for vending granular materials as claimed in claim 14 further comprising an optic sensor coupled to said cabinet; said control system coupled to said optic sensor; wherein said optic sensor provides feedback to said control system when the vending container has been filled with a predetermined amount of the granular materials.
